(19) United States
(12) Patent Application Publication
(10) Pub. No.: US 2014/0019099 A1
(43) Pub. Date: Jan. 16, 2014

(54) Determination Of Failure In Sheet Metal Forming Simulation Using Isotropic Metal Failure Criteria

(71) Applicants: Xinhai Zhu, Pleasanton, CA (US); Li Zhang, Rochester Hills, MI (US)

(72) Inventors: Xinhai Zhu, Pleasanton, CA (US); Li Zhang, Rochester Hills, MI (US)

(73) Assignee: LIVERMORE SOFTWARE TECHNOLOGY CORP, Livermore, CA (US)

(21) Appl. No.: 13/549,980

(22) Filed: Jul. 16, 2012

(51) Int. Cl. G06F 17/10

(52) U.S. Cl. 703/2

(57) ABSTRACT

Systems and methods of determining structural failure in a computer simulation of manufacturing a sheet metal part are disclosed. A FEA model defined for a sheet metal manufacturing procedure includes a plurality of shell elements representing sheet metal blank. Shell elements are configured for emulating anisotropic material properties of the sheet metal. Numerically-simulated structural behaviors are obtained by conducting a computer simulation of manufacturing the sheet metal part using the FEA model with a metal forming simulation application module. The numerically-simulated structural behaviors include structural deformations in forms of equivalent strain and plastic flow direction during forming of the sheet metal part. A structural failure determination criterion is constructed using a planar isotropic material model of the sheet metal. Finally, the obtained structural behaviors are compared with the failure determination criterion to determine whether there is a structural failure in the computer simulation of manufacturing the sheet metal part.

### FIELD OF THE INVENTION

The present invention generally relates to computer aided engineering analysis, more particularly to determination of failure in computer simulation of sheet metal forming using isotropic metal failure criteria.

### BACKGROUND OF THE INVENTION

Many sheet metal parts are manufactured via sheet metal forming. One of the most used sheet metal forming processes is deep drawing, which involves a hydraulic or mechanical press pushing a specially-shaped punch into a matching die with a piece of blank sheet metal in between. FIG. 1 shows an exemplary deep drawing setup, in which a punch 104 is pushed into a die 108 with a blank sheet metal 106 in between. Exemplary products made from this process include, but are not limited to, car hood, fender, door, automotive fuel tank, kitchen sink, aluminum can, etc. In deep drawing, the depth of a sheet metal part being made is generally more than half its diameter. As a result, the blank is stretched and therefore thinned in various locations due to the geometry of the part. Manufactured parts are good when there is no structural defect such as material failure (e.g., cracking, tearing, wrinkling, necking, etc.). Sheet metal blank, in general, possesses anisotropic material properties. As shown in FIG. 2, a piece of sheet metal 202 has two distinct directions: longitudinal or rolling direction 212 and transverse direction 214.

With advent of computer technology, the entire deep draw manufacturing procedure can be numerically simulated using computer aided engineering analysis (e.g., finite element analysis (FEA)). FEA is a computerized method widely used in industry to model and solve engineering problems relating to complex systems such as three-dimensional non-linear structural design and analysis. FEA derives its name from the manner in which the geometry of the object under consideration is specified. With the advent of the modern digital computer, FEA has been implemented as FEA software. Basically, the FEA software is provided with a model of the geometric description and the associated material properties at each point within the model. In this model, the geometry of the system under analysis is represented by solids, shells and beams of various sizes, which are called elements. The vertices of the elements are referred to as nodes. The model is comprised of a finite number of elements, which are assigned a material name to associate the elements with the material properties. The model thus represents the physical space occupied by the object under analysis along with its immediate surroundings. The FEA software then refers to a table in which the properties (e.g., stress-strain constitutive equation, Young's modulus, Poisson's ratio, thermo-conductivity) of each material type are tabulated. Additionally, the conditions at the boundary of the object (i.e., loadings, physical constraints, etc.) are specified. In this fashion a model of the object and its environment is created.

Prior art approach for determining or predicting whether a formed sheet metal part has any structural failure is based on forming limit diagram (FLD). An exemplary FLD 300 is shown in FIG. 3. However, determining structural failure in a computer simulation of a deep draw manufacturing procedure is problematic when the failure determination criterion is based on anisotropic material model, for example, difficulty to determine failure with two forming limits in rolling and transverse directions 412-414 in a path-independent FLD shown in FIG. 4. Therefore, it would be desirable to have a more reliable approach to determining structural failure in a computer simulation of manufacturing a sheet metal part.

### SUMMARY OF THE INVENTION

This section is for the purpose of summarizing some aspects of the present invention and to briefly introduce some preferred embodiments. Simplifications or omissions in this section as well as in the abstract and the title herein may be made to avoid obscuring the purpose of the section. Such simplifications or omissions are not intended to limit the scope of the present invention.

Systems and methods of determining structural failure in a computer simulation of manufacturing a sheet metal part are disclosed. According to one aspect of the invention, a finite element analysis (FEA) model is defined for a sheet metal manufacturing procedure. The FEA model includes a plurality of shell elements representing sheet metal blank. The shell elements are configured for emulating anisotropic material properties of the metal. Numerically-simulated structural behaviors are then obtained by conducting a computer simulation of manufacturing the sheet metal part using the FEA model with a metal forming simulation application module (e.g., FEA application module). The numerically-simulated structural behaviors include structural deformations in forms of equivalent strain and plastic flow direction during forming of the sheet metal part. A structural failure determination criterion is constructed using a planar isotropic material model of the sheet metal. Finally, the obtained structural behaviors are compared with the failure determination criterion to determine whether there is a structural failure in the computer simulation of manufacturing the sheet metal part.

Objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will be better understood with regard to the following description, appended claims, and accompanying drawings as follows:

FIG. 1 is a diagram showing an exemplary deep draw manufacturing setup;

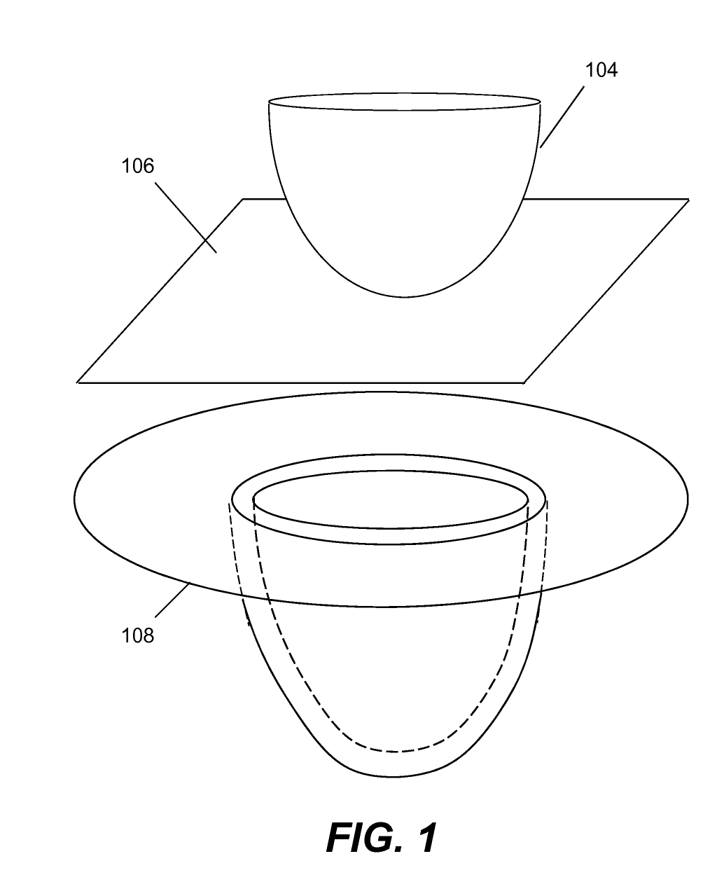

FIG. 2 is a diagram showing rolling and transverse directions of an exemplary piece of sheet metal;

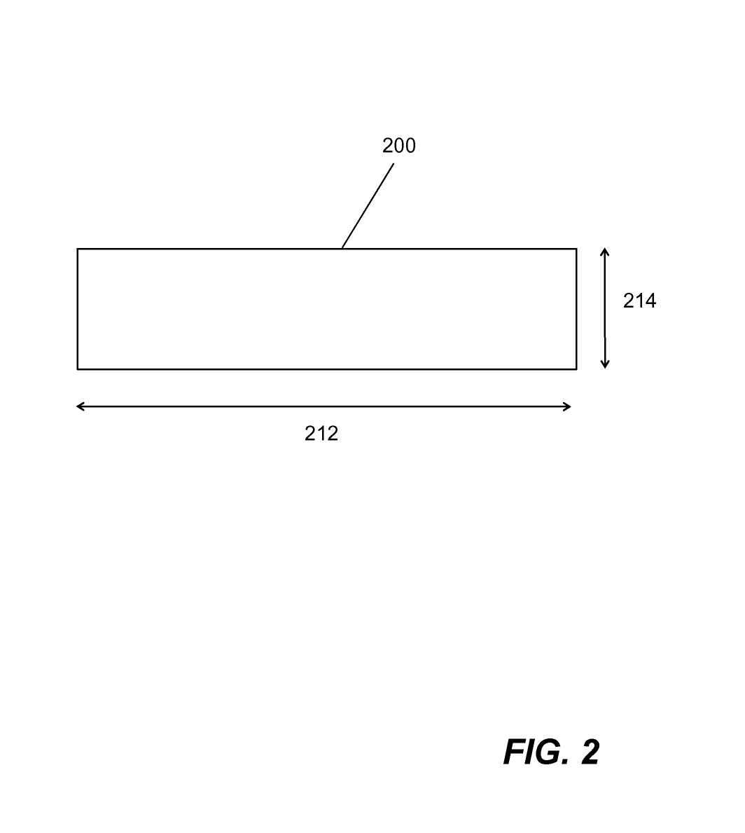

FIG. 3 shows an exemplary traditional forming limit diagram (FLD), which is strain path dependent;

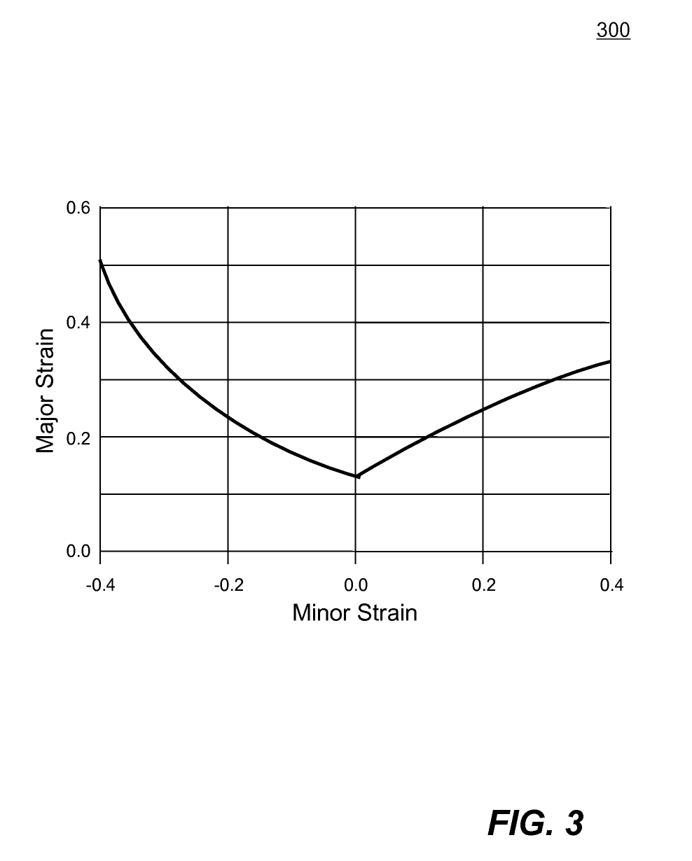

FIG. 4 shows an exemplary path-independent FLD comprising two different forming limits in rolling and transverse directions;

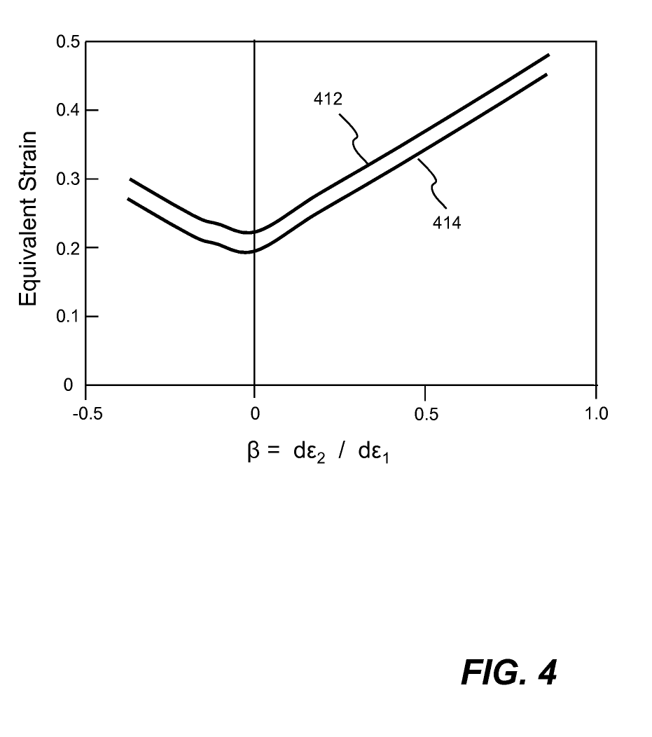

FIG. 5 is a diagram showing an exemplary FLD created from an isotropic material model in accordance with an embodiment of the present invention;

FIG. 6 is a flowchart illustrating an exemplary process of determining failure of a sheet metal part in a computer simulation of sheet metal manufacturing procedure using a failure determination criterion based on isotropic material model, according to an embodiment of the present invention; and

FIG. 7 is a function block diagram showing salient components of an exemplary computer, in which one embodiment of the present invention may be implemented.

### DETAILED DESCRIPTION

In the following description, numerous specific details are set forth in order to provide a thorough understanding of the present invention. However, it will become obvious to those skilled in the art that the present invention may be practiced without these specific details. The descriptions and representations herein are the common means used by those experienced or skilled in the art to most effectively convey the substance of their work to others skilled in the art. In other instances, well- known methods, procedures, and components have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

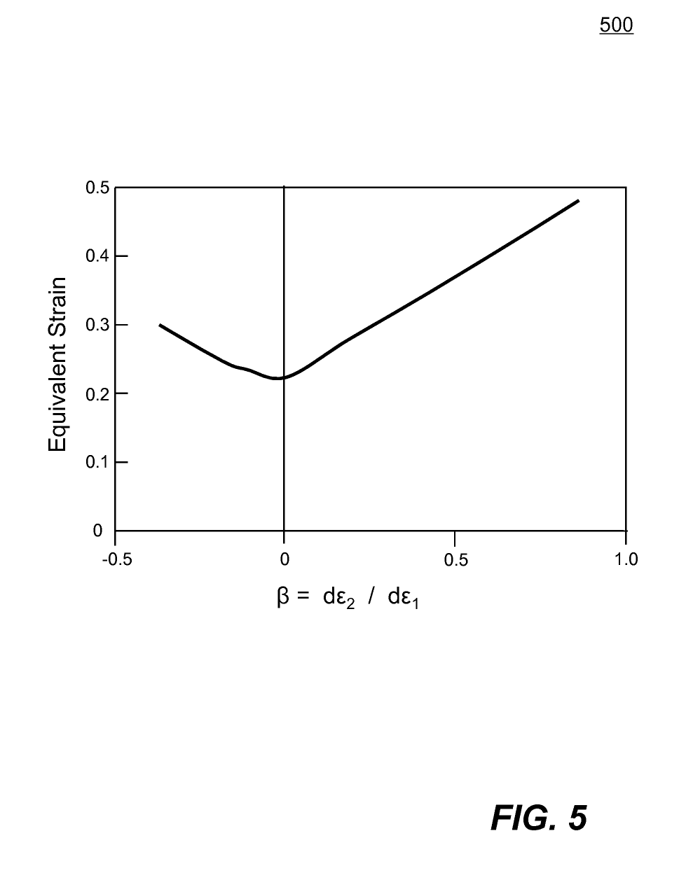

Embodiments of the present invention are discussed herein with reference to FIGS. 5-7. However, those skilled in the art will readily appreciate that the detailed description given herein with respect to these figures is for explanatory purposes as the invention extends beyond these limited embodiments.

Systems and methods of determining structural failure in a computer simulation of manufacturing a sheet metal part are disclosed. According to one aspect of the invention, a finite element analysis (FEA) model is defined for a sheet metal manufacturing procedure. The FEA model includes a plurality of shell elements representing sheet metal blank. The shell elements are configured for emulating anisotropic material properties of the sheet metal. Numerically-simulated structural behaviors are then obtained by conducting a computer simulation of manufacturing the sheet metal part using the FEA model with a metal forming simulation application module (e.g., FEA application module). The numerically-simulated structural behaviors include structural deformations in forms of equivalent strain and plastic flow direction during forming of the sheet metal. A structural failure determination criterion is constructed using a planar isotropic material model of the sheet metal. Finally, the obtained structural behaviors are compared with the failure determination criterion to determine whether there is a structural failure in the computer simulation of manufacturing the sheet metal part.

The path-independent FLD defines forming limit strain based on equivalent plastic strain ε̅^{eq} (which is related to the yield surface size or effective stress σ̅_̅{̅c̅}̅). Such criterion results into a curve in a plot of the size of yield surface versus the current direction of plastic flow as shown in FIG. 5. The current flow direction β (or current strain ratio) is defined as the ratio of current incremental minor strain over

incremental major strain as follows:

$$β = \frac{d {ɛ}_{2}}{d {ɛ}_{1}} ,$$

where ε₁ is major strain, while ε₂ is minor strain.

It can be shown that β is uniquely related to the minor over major stress ratio (σ₂/σ₁) for associated flow rule with a homogeneous yield surface function. In most general term the equivalent strain can be expressed as ε̅^{eq}=f(β, Material Properties).

For a material obeying the power law hardening σ=Kεⁿ, which leads to ε̅^{eq}=f(β, K,n,r), where “r” is Lankford parameter for yield surface. Using Hill's planar—isotropic yield criterion (i.e., a special case under planar isotropic condition), the equivalent strain is expressed as follows:

$${\overline{ɛ}}^{eq} = \frac{1 + r}{\sqrt{1 + 2 r}} \sqrt{{ɛ}_{major}^{2} + {ɛ}_{minor}^{2} + \frac{2 r}{1 + r} {ɛ}_{major} {ɛ}_{minor}} \qquad ( 1 )$$

It is noted that Equation (1) depends upon yield surface type. The special planar isotropic case, sometimes, is denoted as a R00=R45=R90 case.

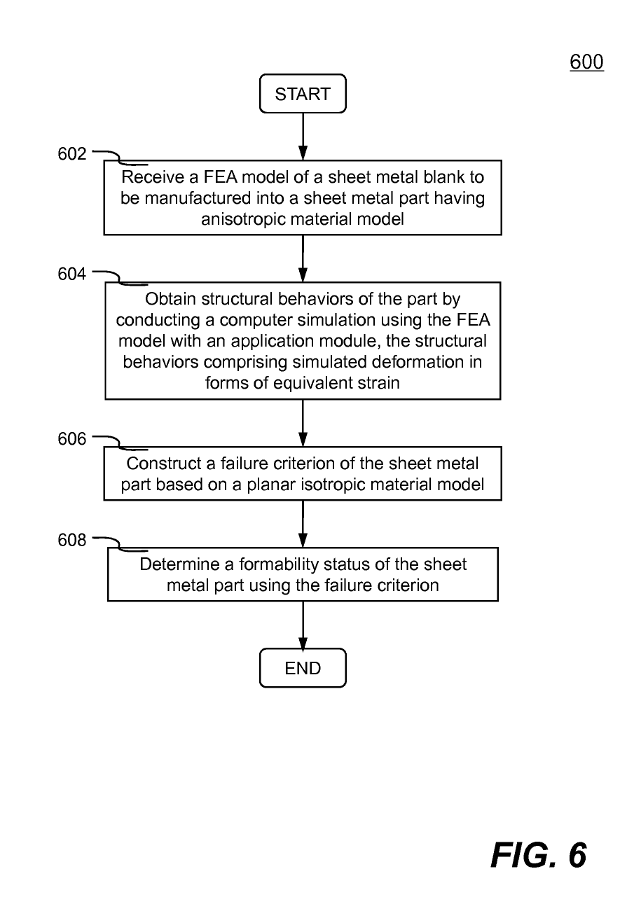

Referring now to FIG. 6, it is illustrated a flowchart of an exemplary process 600 for determining structural failure in a computer simulation of manufacturing a sheet metal part, according one embodiment of the present invention. Process 600 is implemented in software.

Process 600 starts by defining and receiving a finite element analysis (FEA) model in a computer system at step 602. The FEA model contains a plurality of shell finite elements representing a sheet metal blank. The shell elements are configured for emulating anisotropic material properties of sheet metal. In other words, the shell elements are capable of approximating the structural behaviors of anisotropic material properties of the sheet metal. Next, at step 604, numerically-simulated structural behaviors are obtained by conducting a computer simulation of manufacturing the sheet metal part (i.e., time-marching simulation of a deep draw manufacturing procedure of a sheet metal part). The computer simulation is conducted using the FEA model with a sheet metal forming simulation application module installed on the computer system. The structural behaviors include, but are not limited to, structural deformations in forms of equivalent strains and plastic flow.

At step 606, a structural failure determination criterion is constructed based on planar isotropic material model of the sheet metal. For example, forming limit diagram 500 shown in FIG. 5 can be used as a structural failure determination criterion. Finally, at step 608, using the obtained structural behaviors with the structural failure determination criterion, process 600 determines a formability status of the sheet metal part.

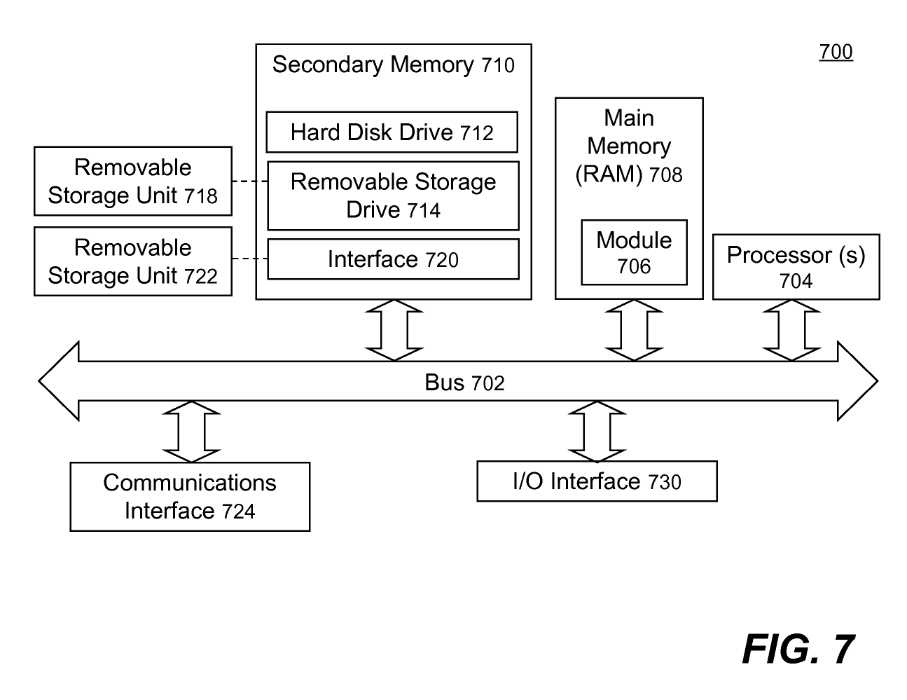

According to one aspect, the present invention is directed towards one or more computer systems capable of carrying out the functionality described herein. An example of a computer system 700 is shown in FIG. 7. The computer system 700 includes one or more processors, such as processor 704. The processor 704 is connected to a computer system internal communication bus 702. Various software embodiments are described in terms of this exemplary computer system. After reading this description, it will become apparent to a person skilled in the relevant art(s) how to implement the invention using other computer systems and/or computer architectures.

Computer system 700 also includes a main memory 708, preferably random access memory (RAM), and may also include a secondary memory 710. The secondary memory 710 may include, for example, one or more hard disk drives 712 and/or one or more removable storage drives 714, representing a floppy disk drive, a magnetic tape drive, an optical disk drive, etc. The removable storage drive 714 reads from and/or writes to a removable storage unit 718 in a well-known manner. Removable storage unit 718, represents a floppy disk, magnetic tape, optical disk, etc. which is read by and written to by removable storage drive 714. As will be appreciated, the removable storage unit 718 includes a computer usable storage medium having stored therein computer software and/or data.

In alternative embodiments, secondary memory 710 may include other similar means for allowing computer programs or other instructions to be loaded into computer system 700. Such means may include, for example, a removable storage unit 722 and an interface 720. Examples of such may include a program cartridge and cartridge interface (such as that found in video game devices), a removable memory chip (such as an Erasable Programmable Read-Only Memory (EPROM), Universal Serial Bus (USB) flash memory, or PROM) and associated socket, and other removable storage units 722 and interfaces 720 which allow software and data to be transferred from the removable storage unit 722 to computer system 700. In general, Computer system 700 is controlled and coordinated by operating system (OS) software, which performs tasks such as process scheduling, memory management, networking and I/O services.

There may also be a communications interface 724 connecting to the bus 702. Communications interface 724 allows software and data to be transferred between computer system 700 and external devices. Examples of communications interface 724 may include a modem, a network interface (such as an Ethernet card), a communications port, a Personal Computer Memory Card International Association (PCMCIA) slot and card, etc. Software and data transferred via communications interface 724. The computer 700 communicates with other computing devices over a data network based on a special set of rules (i.e., a protocol). One of the common protocols is TCP/IP (Transmission Control Protocol/Internet Protocol) commonly used in the Internet. In general, the communication interface 724 manages the assembling of a data file into smaller packets that are transmitted over the data network or reassembles received packets into the original data file. In addition, the communication interface 724 handles the address part of each packet so that it gets to the right destination or intercepts packets destined for the computer 700. In this document, the terms “computer program medium”, “computer readable medium”, “computer recordable medium” and “computer usable medium” are used to generally refer to media such as removable storage drive 714 (e.g., flash storage drive), and/or a hard disk installed in hard disk drive 712. These computer program products are means for providing software to computer system 700. The invention is directed to such computer program products.

The computer system 700 may also include an input/output (I/O) interface 730, which provides the computer system 700 to access monitor, keyboard, mouse, printer, scanner, plotter, and the likes.

Computer programs (also called computer control logic) are stored as application modules 706 in main memory 708 and/or secondary memory 710. Computer programs may also be received via communications interface 724. Such computer programs, when executed, enable the computer system 700 to perform the features of the present invention as discussed herein. In particular, the computer programs, when executed, enable the processor 704 to perform features of the present invention. Accordingly, such computer programs represent controllers of the computer system 700.

In an embodiment where the invention is implemented using software, the software may be stored in a computer program product and loaded into computer system 700 using removable storage drive 714, hard drive 712, or communications interface 724. The application module 706, when executed by the processor 704, causes the processor 704 to perform the functions of the invention as described herein.

The main memory 708 may be loaded with one or more application modules 706 (e.g., FEM and/or SPH application module) that can be executed by one or more processors 704 with or without a user input through the I/O interface 730 to achieve desired tasks. In operation, when at least one processor 704 executes one of the application modules 706, the results are computed and stored in the secondary memory 710 (i.e., hard disk drive 712). Results of the analysis (e.g., formability index time histories) are reported to the user via the I/O interface 730 either in a text or in a graphical representation upon user's instructions.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, whereas Hill's yield surface has been shown and described to derive Equation (1). Other equivalent methods can be used instead, for example, a general relationship between equivalent strain and effective stress. In summary, the scope of the invention should not be restricted to the specific exemplary embodiments disclosed herein, and all modifications that are readily suggested to those of ordinary skill in the art should be included within the spirit and purview of this application and scope of the appended claims.

What is claimed is:

1. A method of determining structural failure in a computer simulation of manufacturing a sheet metal part, said method comprising:
receiving, in a computer system, a finite element analysis (FEA) model including a plurality of shell elements representing a blank sheet metal to be manufactured into a sheet metal part, said plurality of shell elements being configured for emulating anisotropic material properties of the blank sheet metal;
obtaining numerically-simulated structural behaviors of the sheet metal part being manufactured from a blank sheet metal blank by conducting a computer simulation using the FEA model with a sheet metal forming simulation application module installed in the computer system, said numerically-simulated structural behaviors comprises numerically-simulated deformation in forms of said shell elements' equivalent strain and corresponding strain ratio;
constructing a failure determination criterion of the sheet metal part based on a planar isotropic material model of the sheet metal blank; and
determining a formability status of the sheet metal part after the computer simulation using the failure determination criterion and the numerically-simulated structural behaviors.

2. The method of claim 1, wherein the computer simulation includes simulating a punch being press into a die with the blank sheet metal in between.

3. The method of claim 1, wherein the anisotropic material model is based on anisotropic yield surface of the sheet metal.

4. The method of claim 1, wherein said failure determination criterion comprises a path-independent forming limit diagram (FLD) in forms of equivalent strain ε̅ ^{eq} versus a direction of plastic flow that is defined by said shell elements' strains.

5. The method of claim 4, wherein the path-independent FLD comprises using following equation:
$${\overline{ɛ}}^{eq} = \frac{1 + r}{\sqrt{1 + 2 r}} \sqrt{{ɛ}_{major}^{2} + {ɛ}_{minor}^{2} + \frac{2 r}{1 + r} {ɛ}_{major} {ɛ}_{minor}}$$
where εₘₐⱼₒᵣ is major strain, εₘᵢₙₒᵣ is minor strain and r is a parameter for the planar isotropic material model.

6. A system for determining structural failure in a computer simulation of manufacturing a sheet metal part, the system comprises:
an input/output (I/O) interface;
a memory for storing computer readable code for a sheet metal forming simulation application module;
at least one processor coupled to the memory, said at least one processor executing the computer readable code in the memory to cause the sheet metal forming simulation application module to perform operations of:
receiving a finite element analysis (FEA) model including a plurality of shell elements representing a blank sheet metal to be manufactured into a sheet metal part, said plurality of shell elements being configured for emulating anisotropic material properties of the blank sheet metal;
obtaining numerically-simulated structural behaviors of the sheet metal part being manufactured from a blank sheet metal blank by conducting a computer simulation using the FEA model with the sheet metal forming simulation application module, said numerically-simulated structural behaviors comprises numerically-simulated deformation in forms of said shell elements' equivalent strain and corresponding strain ratio;
constructing a failure determination criterion of the sheet metal part based on an assumption using a planar isotropic material model of the sheet metal blank; and
determining a formability status of the sheet metal part after the computer simulation using the failure determination criterion and the numerically-simulated structural behaviors.

7. A non-transitory computer readable storage medium containing computer executable instructions for determining structural failure in a computer simulation of manufacturing a sheet metal part by a method comprising:
receiving, in a computer system, a finite element analysis (FEA) model including a plurality of shell elements representing a blank sheet metal to be manufactured into a sheet metal part, said plurality of shell elements being configured for emulating anisotropic material properties of the blank sheet metal;
obtaining numerically-simulated structural behaviors of the sheet metal part being manufactured from a blank sheet metal blank by conducting a computer simulation using the FEA model with a sheet metal forming simulation application module installed in the computer system, said numerically-simulated structural behaviors comprises numerically-simulated deformation in forms of said shell elements' equivalent strain and corresponding strain ratio;
constructing a failure determination criterion of the sheet metal part based on an assumption using a planar isotropic material model of the sheet metal blank; and
determining a formability status of the sheet metal part after the computer simulation using the failure determination criterion and the numerically-simulated structural behaviors.
